(19) United States
(12) Patent Application Publication
(10) Pub. No.: US 2017/0110272 A1
(43) Pub. Date: Apr. 20, 2017

(54) MODIFIED AIRCRAFT SWITCH

(71) Applicant: Alan PAINE, SAN DIMAS, CA (US)

(72) Inventor: Alan PAINE, SAN DIMAS, CA (US)

(21) Appl. No.: 15/283,692

(22) Filed: Oct. 3, 2016

Related U.S. Application Data
(60) Provisional application No. 62/242,131, filed on Oct. 15, 2015.

(51) Int. Cl. H01H 23/06; H01H 11/00; H01H 23/14

(52) U.S. Cl. CPC H01H 23/06; H01H 23/145; H01H 11/0006; H01H 2239/034; H01H 2231/016; H01H 2223/002

(57) ABSTRACT

Improvements a modified aircraft switch to protect from Foreign Object Debris (FOD) failure. The aircraft switch is manufactured from the factory as a new OEM switch, but can also be modified from a pre-existing switch. The switch and method to modify a switch to protect a widely used existing switch in military and commercial aircraft that is failing from Foreign Object Debris intrusion and failure from FOD.

### CROSS REFERENCE TO RELATED APPLICATIONS

This application claims the benefit of Provisional Application Ser. No 62/242,131 filed Oct. 15, 2015 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the invention

This invention relates to improvements in a modified Aircraft Switch. More particularly, the present modified aircraft switch improves the sealing of the switch to prevent pre-mature failure due to foreign objection debris (FOD) intrusion.

Description of Related Art including information disclosed under 37 CFR 1.97 and 1.98.

Military and other aircrafts use a number of switches to control the aircraft and instruments. One of the most common types of this switch are AML series 20 that is a three—position, four-pole self-centering rocker switch. The switch has 12 contact pins that fits a large number of aircraft. While this document identifies modification of the switch, the switch could be manufactured in the same or similar sealed arrangement identified in this document.

A number of patents and or publications have been made to address these issues. Exemplary examples of patents and or publication that try to address this/these problem(s) are identified and discussed below.

U.S. Pat. No. 7,732,722 issued on Jun. 8, 2010 discloses a Hermetically sealed pressure switch with composite actuation mechanism and U.S. Pat. No. 6,121,561 issued on Sep. 19, 2000 discloses a disclose Hermetically sealed electrical switch. While these patents disclose sealed switches, the switches are not drop-in replacement for switches used in aircraft.

What is needed is sealed switch used in aircraft where the switch is manufactured as a sealed switch or is modified to create a sealed switch that is not effected by foreign contamination. The proposed switch provides a solution.

### BRIEF SUMMARY OF THE INVENTION

It is an object of the modified aircraft switch to protect from Foreign Object Debris (FOD) failure. One of the primary reasons for failure of a switch is from foreign debris that enters into the housing. The debris often comes from air movement around the switch. Often this debris is small enough that it moves through the edges of the switch and accumulates in the housing to cause failure.

It is another object of the modified aircraft switch to provide a method to protect a widely used existing switch in military and commercial aircraft that is failing from FOD intrusion and failure from FOD. Switch failure in military and commercial airlines can result in a catastrophic failure.

It is another object of the modified aircraft switch to include elastomeric or silicon seals that are not present in the switch. The seals allow the mechanical components to move when they are being moved and maintains the seal.

It is another object of the modified aircraft switch to utilize sealant in the terminals that exit the housings. The switch leads must pass through openings in the hard plastic housings and result in openings where contamination can enter the switch housing. Sealing these openings prevents intrusion into the openings and also locks the switch terminals into position.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a transparent view of sealed switch.

FIG. 2 shows a bottom view of the switch

FIG. 3 shows an exploded view of the switch components.

FIG. 4 shows a perspective view of the switch.

FIG. 5 shows a bottom view of the switch.

FIG. 6 shows a circuit diagram of the switch.

FIG. 7 shows the specifications for the switch.

FIG. 8 shows a description of the process to produce the switch.

FIG. 9 shows a perspective view of the silicone membrane.

### DETAILED DESCRIPTION OF THE INVENTION

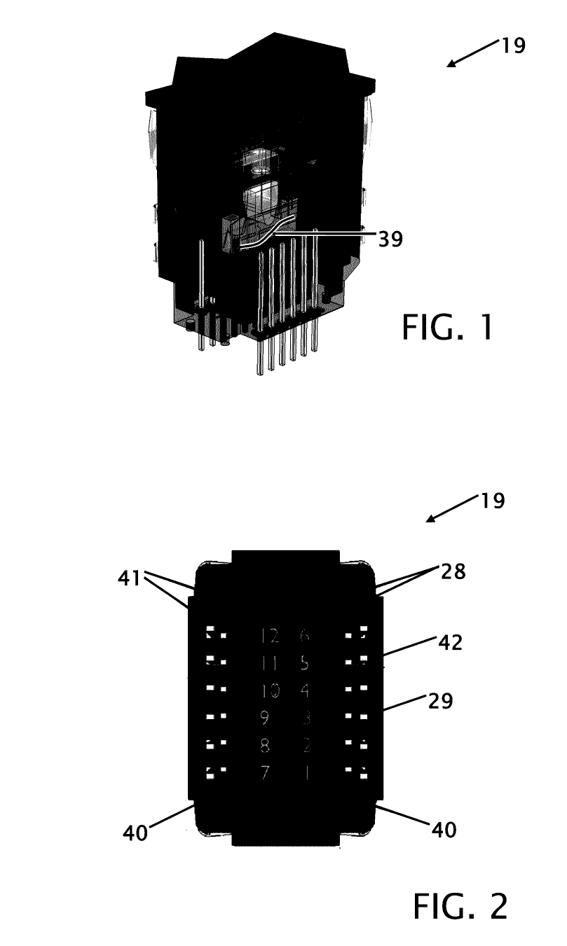

FIG. 1 shows a transparent view of sealed switch 19. Internally, the switch has silicone gel filled, encapsulated contacts 39 that provide some protection from contamination reaching the electrical contact.

FIG. 2 shows a bottom view of the switch 19. A sealing adhesive, such as #3314 red adhesive 28 is applied around the contact pins 29. The sealing adhesive 28 is also placed around the four sides 40 of the switch 19. The sealing adhesive can extend 41 to the edges of the terminal recess 42.

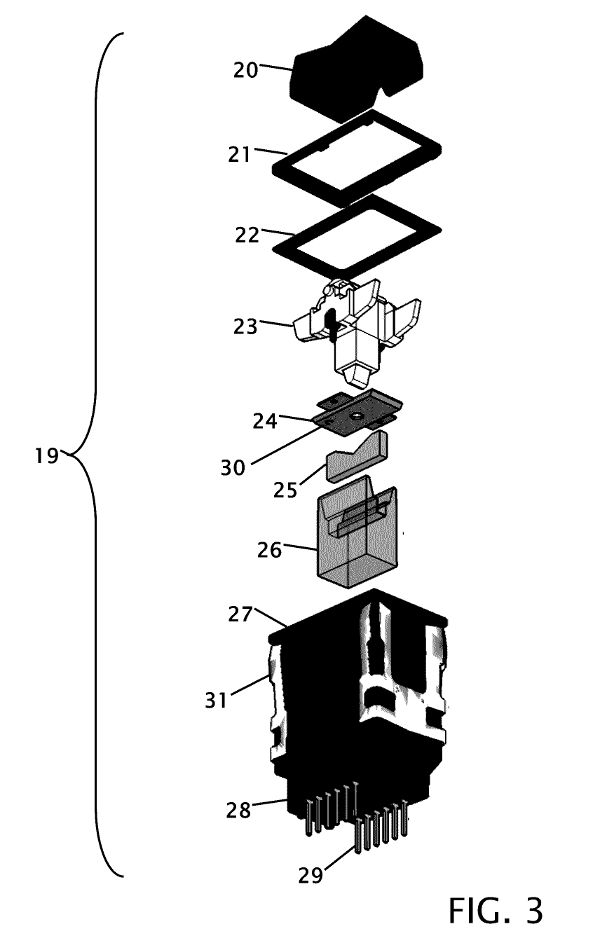

FIG. 3 shows an exploded view of the switch components. This figure shows the rocker button 20 on top of a bezel 21 that holds and seals the rocker button opening with a dust shield 22. The top bezel is an additional improvement to the stock switch 19 and is preferably made from a stainless steel, aluminum or other material that resists corrosion. The dust shield 22 is also an improvement to seal from foreign debris and is preferably made from silicone impregnated fibers.

The actuator 23 is located under the dust shield 22. The underside of the actuator includes another improvement consisting of a silicon membrane 24. The silicon membrane has a pressure relief 30 slit or opening that relieves changes in pressure within the switch as an aircraft changes elevation. The switch contacts cavity is sealed completely with silicone gel. A center bearing 25 can operate on an optional silicone displacer 26. The silicone displacer 26 reduces the free air volume within the switch to reduce the volume of air movement in and out of the switch from pressure change in an aircraft. These pieces are held within a switch body with gold terminals 29. The switch body 27 has a plurality of locks 31 on the outside of the switch body 27 that retains the switch 19 within an aircraft dashboard or console. The bottom of the switch 19 is sealed 28 and previously shown and described. The terminals 29 are preferably gold plated for improved electrical conduction through the switch terminals.

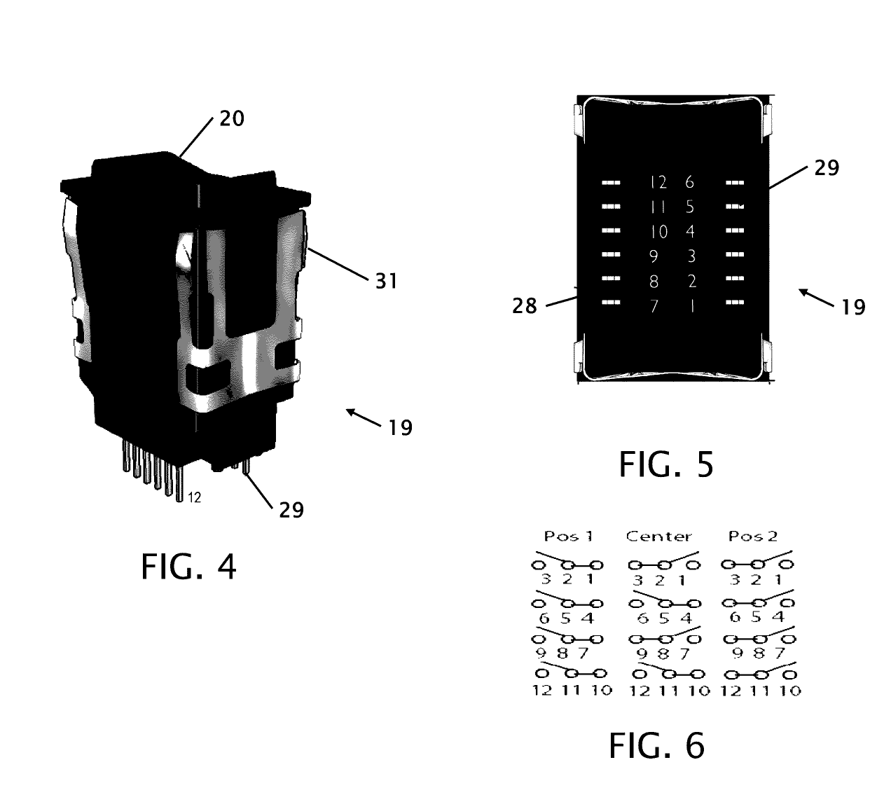

FIG. 4 shows a perspective view of the switch 19. Advantages of modifications to an existing switch include the fact that the switch 19 is popular with thousands already in service. By modifying the existing switch to enhance its environmental performance and giving it Foreign Object Debris (FOD) defense, the aircraft wiring harness and panel cutout area will remain unchanged to allow the rocker 20, spring terminal locks 31 and the electrical contact 29 to remain intact with the non-modified switch.

FIG. 5 shows a bottom view of the switch and FIG. 6 shows a circuit diagram of the switch. The wiring pins out of the switch will not change, allowing the easy replacement of the failure switch, and the pole position configurations are unique.

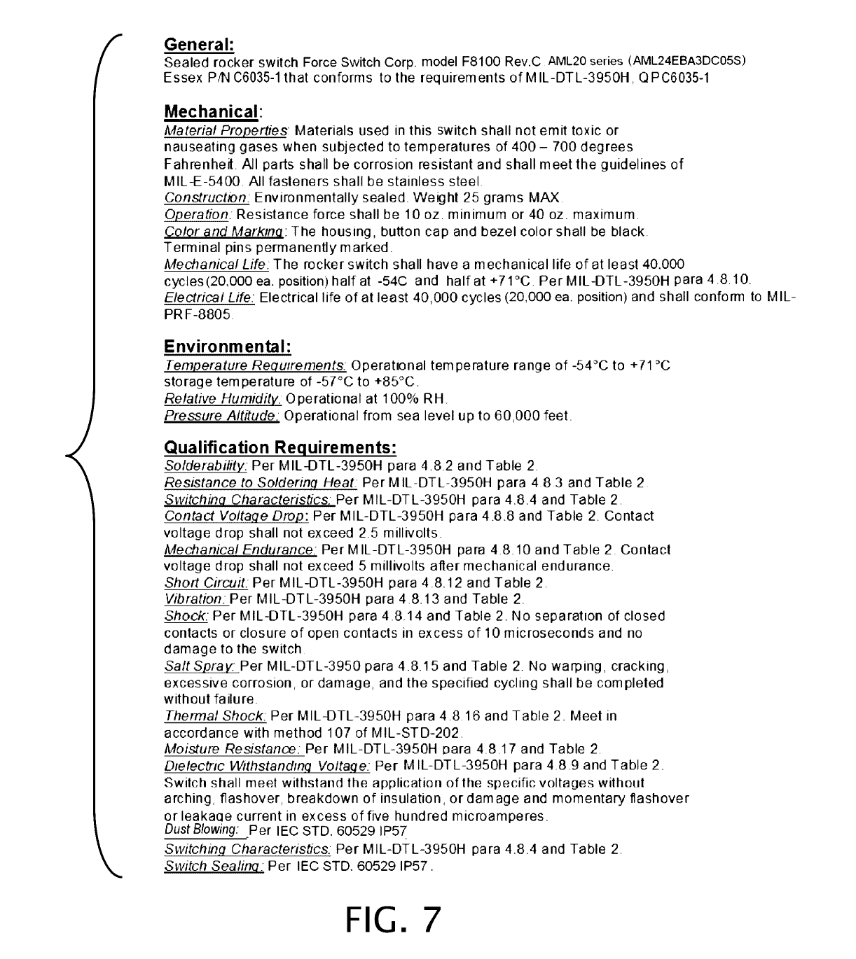

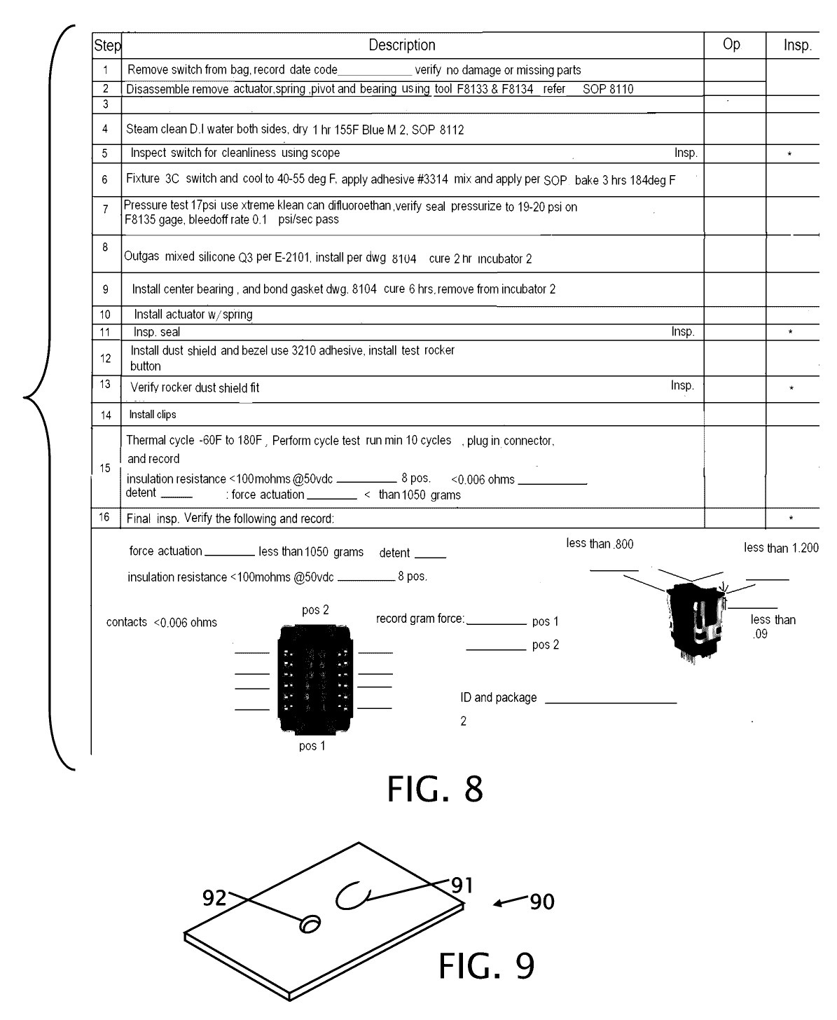

FIG. 7 shows the specifications for the switch and FIG. 8 shows a description of the process to produce the switch. This modification to the switch allows it to function as originally designed with the added FOD proofing. The detent and action of this rocker switch is essentially unchanged.

The method of the modification includes disassembling the switch by removing retaining clips, a test rocker button 20, an actuator spring 23, a pivot and a bearing 25 from a housing 27. Steam cleaning said actuator spring 23, said pivot and the bearing with deionized water. The parts are then inspected cleanliness after the steam cleaning.

The switch housing is then cooled to 40-55 degrees Fahrenheit. An adhesive 28 is the applied to the switch body 27 around electrical contacts and then curing the adhesive. The adhesive 28 is cured for about three hours at 184 degrees Fahrenheit.

The sealed housing is the pressure tested 17 psi using xtreme klean can difluoreothan. The seal is verified at a pressure of 19 to 20 psi with a bleedoff rate of 0.1 psi per second.

Silicone Q3 is mixed and outgasses. The outgassed silicone mixture is the cured for about 2 hours. The center bearing 25 is installed and bonded to the gasket 24, and then allowed to cure for about 6 hours.

The actuator 23 and the spring is then installed. The dust shield 22 and bezel 21 is installed with an adhesive. The test rocker button 20 is also installed and the fit with the rocker dust shield is checked.

The clips are then installed ant the modified switch assembly is the thermally cycled and the modified switch is tested and inspected. The results of all testing is recorded.

The modification to the switch protects it from foreign debris and other material entering into, and causing interference between the switch contacts. This switch modification does not completely stop debris from entering the switch body, but does not allow debris to interfere with the crucial contact area.

Modification by the addition of the dust shield protects the switch from fluids and debris, and a further inner membrane that has altitude change relief protects internal moving part from FOD.

FIG. 9 shows a perspective view of the silicone membrane 90. The membrane has a pressure relief portion 91 which allows for changes caused by altitude variation. A hole 92 locates the silicon membrane and seals the area around the contacts.

The modification limits size of debris from entering the body of the switch that would cause a malfunction, after the modification sealing up the switch, it is then able to pass the harsh mil spec sand and dust test, and the mil spec altitude test. This was not achievable by utilizing a flexible boot over the switch. The boot changes the detent on the switch and was not acceptable to the customer, the boot also left areas of the switch open and allowed contacts to fail because the switch has difficulty passing altitude testing.

This modification improved the switch by adding components that allow the switch to meet the mil spec sealed status by passing the sand and dust, moisture, salt spray and altitude tests. The modification will allow the high failure rate of the un-modified switch to cease.

Thus, specific embodiments of a modified or manufactured aircraft switch have been disclosed. It should be apparent, however, to those skilled in the art that many more modifications besides those described are possible without departing from the inventive concepts herein. The inventive subject matter, therefore, is not to be restricted except in the spirit of the appended claims.

1. A modified aircraft switch comprising:
a switch body;
said switch body has a rocker button retained under a bezel;
said bezel covering a dust shield;
said switch body further includes an actuator on a silicon membrane, and
said silicon membrane operating on a center bearing.

2. The modified aircraft switch according to claim 1 further including a displacer.

3. The modified aircraft switch according to claim 2 wherein said displacer displaces unused volume within said switch.

4. The modified aircraft switch according to claim 1 wherein said switch body further including a plurality of retaining clips.

5. The modified aircraft switch according to claim 1 wherein said switch body further includes gold contact terminals.

6. The modified aircraft switch according to claim 1 wherein said switch contacts cavity is sealed completely with silicone gel.

7. The modified aircraft switch according to claim 6 that further includes sealing four side of said switch.

8. The modified aircraft switch according to claim 1 further includes a silicone membrane that has a pressure relief portion which allows for changes caused by altitude variation.

9. The modified aircraft switch according to claim 1 wherein said bezel is made from stainless steel.

10. The modified aircraft switch according to claim 1 wherein said dust shield is made with silicone impregnated fibers.

11. A method of modifying an aircraft switch comprising:
disassembling a switch by removing retaining clips, a test rocker button, an actuator spring, a pivot and a bearing from a housing;
steam cleaning said actuator spring, said pivot and said bearing with deionized water;
applying an adhesive to said switch body around electrical contacts and allowing said adhesive to cure;
pressure testing said housing;
outgassing a silicon mixture;
installing said center bearing and bonding a gasket into said housing;
installing said actuator and said spring into said center bearing;
installing a dust shield and a bezel onto said actuator, and adding an adhesive;
installing said test rocker button, and
installing said retaining clips.

12. The modified aircraft switch according to claim 11 wherein curing of said adhesive is by baking.

13. The modified aircraft switch according to claim 12 wherein said baking is at 184 degrees Fahrenheit.

14. The modified aircraft switch according to claim 12 wherein said baking is for three hours.

15. The modified aircraft switch according to claim 11 wherein said

16. The modified aircraft switch according to claim 11 further includes testing a modified switch.

17. The modified aircraft switch according to claim 11 wherein bonding said gasket to said center bearing further includes curing said bonding agent.

18. The modified aircraft switch according to claim 17 wherein said curing of said bonding agent is in an incubator.

19. The modified aircraft switch according to claim 11 further includes verifying a fit of said dust shield with said test rocker button.

20. The modified aircraft switch according to claim 11 further includes inspecting said switch for cleanliness after said steam cleaning.
